(19) United States
(12) Patent Application Publication
(10) Pub. No.: US 2008/0295806 A1
(43) Pub. Date: Dec. 4, 2008

(54) Heat conducting sleeve for a fuel injector

(75) Inventors: David Y. Chang, Edwards, IL (US); David J. Lin, Peoria, IL (US); Thomas G. Pusch, Edwards, IL (US)

Correspondence Address: Caterpillar Inc.;Intellectual Property Dept., AH 9510, 100 N.E. Adams Street, PEORIA, IL, 61629-9510, US

(73) Assignee: Caterpillar Inc., Peoria, IL (US)

(21) Appl. No.: 11/809,987

(22) Filed: Jun. 4, 2007

(51) Int. Cl. F02M 61/16

(52) U.S. Cl. 123/470

(57) ABSTRACT

An engine comprises a block, a piston, a head, a fuel injector, and a sleeve. The block includes at least one bore. The piston is configured to reciprocate within the bore. The head is coupled to the block and defines with the block and the piston a combustion chamber. The fuel injector is coupled to the head and is configured to deliver fuel to the combustion chamber. The fuel injector includes an actuator extending between a first axial position and a second axial position along a longitudinal axis of the fuel injector. The sleeve is coupled between the head and the fuel injector and extends between a third axial position and a fourth axial position along the axis of the fuel injector. The area between the first and second axial positions at least partially overlaps the area between the third and fourth axial positions.

### TECHNICAL FIELD

The present invention relates generally to fuel injectors. More particularly, the present invention relates to a system for transferring heat away from a fuel injector.

### BACKGROUND

In order to meet the increasingly stringent emissions regulations, diesel engine manufacturers have been exploring different techniques for reducing the regulated components of diesel engine emissions. One approach used to help achieve the reduced emissions is to utilize multiple injections of fuel into the combustion chamber during any particular combustion event. For example, manufacturers currently use a number of different injection strategies, some of which include a pre-injection, a main injection, a post injection, or different combinations of these or other injection types. In most cases, multiple injections are achieved by electrically energizing an actuator (e.g., solenoids, piezo-electric actuators, etc.) that controls the movement of a valve multiple times during each combustion cycle. To accomplish these multiple actuation events, more electrical energy is required. However, the increase in electrical energy supplied to the actuator often results in an increase in the heat energy that is generated. Moreover, the increased number of valve movements may lead to more leakage of high-pressure fuel within the fuel injector. As the pressure of the leaked fuel decreases, the temperature of the fuel may increase significantly, which provides another source of heat energy.

Another approach that is being used to help achieve the reduced emissions is to increase the injection pressures to achieve greater atomization of the fuel when it is injected. However, any leakage of fuel that occurs at these higher fuel pressures tends to generate even more heat energy. Thus, the use of multiple injection events and higher fuel pressures, either individually or together, can have a significant impact on the magnitude of the heat energy to which the components of the fuel injectors are exposed. This is especially problematic in connection with the use of solenoids, which tend to be susceptible to failure at temperatures that can be easily reached if the fuel injector is not sufficiently cooled.

Manufacturers use a number of different techniques to transfer heat energy away from fuel injectors. As just one example of a common technique, U.S. Pat. No. 4,246,877, (“the '877 patent”) issued Jan. 27, 1981, discloses the use of an injector tube that is configured to receive a fuel injector. The injector tube extends between openings through upper and lower cylinder head walls and is exposed to cooling water in an engine cooling jacket that is partly defined by the upper and lower cylinder head walls. The injector tube is made of copper or other suitable heat conducting material to help transfer heat from the fuel injector. Although arrangements similar to the one described in the '877 patent provide some cooling effect, the cooling (or heat transfer) may not be adequately targeted, in some cases, to those components of the fuel injector that are often less able to withstand higher temperatures, such as the solenoid, or to those areas of the fuel injector where much of the heat energy is generated. Other methods suffer from the same shortcoming, or tend to be relatively expensive to implement.

Accordingly, it would be desirable to provide a system for transferring heat energy away from a fuel injector that overcomes one or more of the deficiencies discussed above.

### SUMMARY

According to one exemplary embodiment, an engine comprises a block, a piston, a head, a fuel injector, and a sleeve. The block includes at least one bore. The piston is configured to reciprocate within the bore. The head is coupled to the block and defines with the block and the piston a combustion chamber. The fuel injector is coupled to the head and is configured to deliver fuel to the combustion chamber. The fuel injector includes an actuator extending between a first axial position and a second axial position along a longitudinal axis of the fuel injector. The sleeve is coupled between the head and the fuel injector and extends between a third axial position and a fourth axial position along the axis of the fuel injector. The area between the first and second axial positions at least partially overlaps the area between the third and fourth axial positions.

According to another exemplary embodiment, an engine comprises a block, a piston, a head, a fuel injector, a clamp, and a sleeve. The block includes at least one bore. The piston is configured to reciprocate within the bore. The head is coupled to the block and defines with the block and the piston a combustion chamber. The fuel injector is coupled to the head and is configured to deliver fuel to the combustion chamber. The clamp couples the fuel injector to the head. The sleeve is coupled between the head and the fuel injector and includes an opening for receiving at least a portion of the clamp. The sleeve is configured to conduct heat between the fuel injector and the head.

According to another exemplary embodiment, a method of coupling a fuel injector to a head of an engine comprises the steps of expanding a split sleeve, sliding the sleeve onto the fuel injector in an expanded state, and coupling the sleeve to the head.

### BRIEF DESCRIPTION OF THE DRAWINGS

FIG. 1 is a schematic illustration of an engine according to one exemplary embodiment.

FIG. 2 is a cross-sectional view of a portion of an engine including a fuel injector and a sleeve according to one exemplary embodiment.

FIG. 3 is a cross-sectional view of a portion of the fuel injector and the sleeve of FIG. 2 shown enlarged.

FIG. 4 is a perspective view of the sleeve of FIGS. 2 and 3.

### DETAILED DESCRIPTION

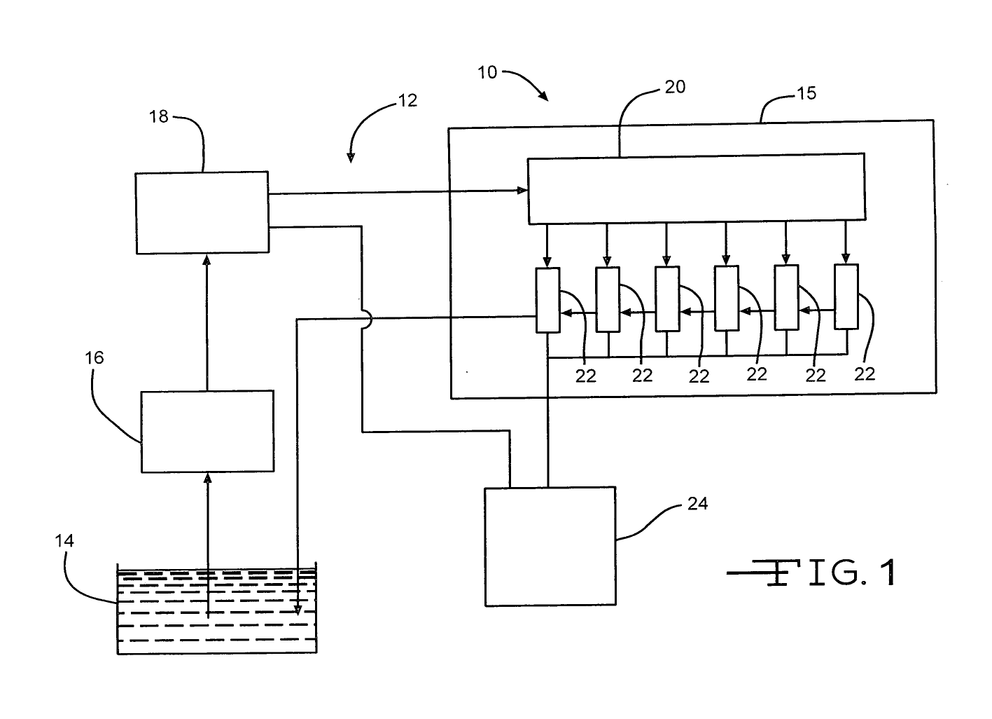

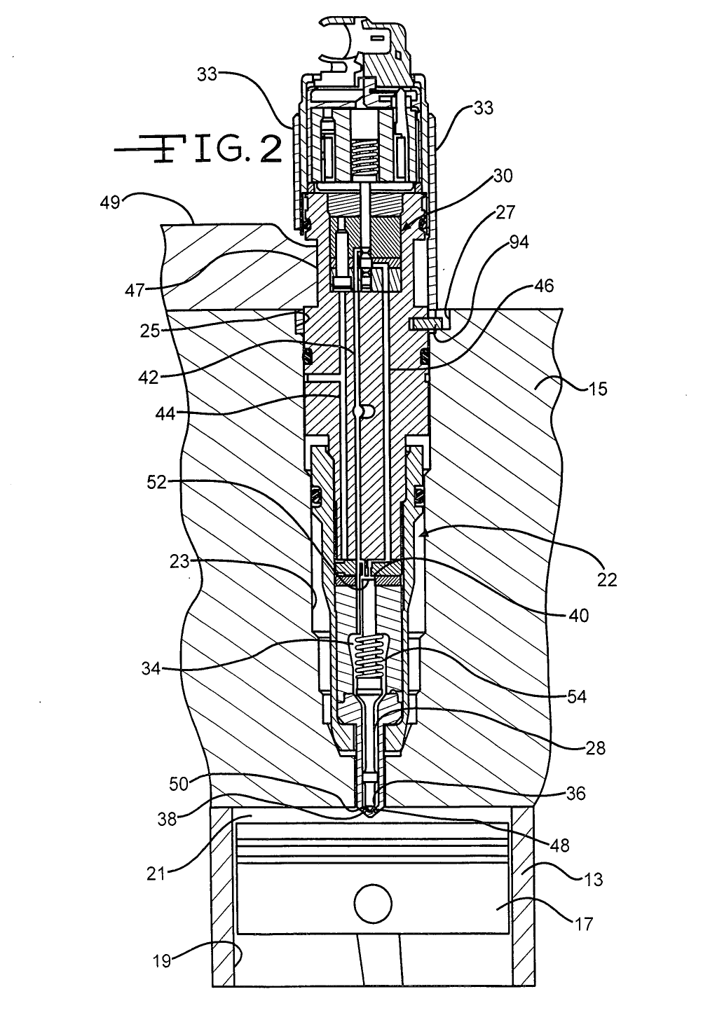

Referring to FIGS. 1 and 2, an engine 10 is shown according to one exemplary embodiment. Engine 10 includes a block 13, a head 15, a piston 17, a crankshaft (not shown), and a fuel system 12.

Block 13 provides the general foundation or base upon which the rest of engine 10 is constructed. According to one exemplary embodiment, block 13 includes at least one bore 19 that is configured to receive a piston 17 in a manner that allows piston 17 to reciprocate within bore 19. Bore 19, together with head 15 and piston 17, define an enclosed combustion chamber 21 in which fuel and air are supplied and combusted to provide the source of power for engine 10. According to various alternative and exemplary embodiments, block 13 may take any one of a variety of different configurations and may include any number of bores (e.g. six and eight bores are common) arranged in any of a number of different configurations (such as an inline, V, opposed, or other configurations, for example).

Head 15 is a device or assembly that is coupled to block 13 in a manner that encloses bore 19 (or bores 19 if block 13 includes multiple bores) so as to form combustion chamber 21. According to one exemplary embodiment, head 15 includes an aperture 23 and a valvetrain (not shown). Aperture 23 extends through head 15 and is configured to receive a fuel injector 22. In the side of head 15 that faces away from block 13, aperture 23 may include an enlarged diameter portion or recess 25 that is configured to receive a sleeve (discussed below). Aperture 23 may also include a notch 27 that is configured to receive an alignment pin 94 coupled to a fuel injector 22 to allow fuel injector 22 to be coupled within head 15 in the appropriate rotational position. The valvetrain is a system of cooperating components that serve to control the flow of air into, and the flow of exhaust out of, combustion chamber 21. According to various exemplary and alternative embodiments, the valvetrain may take any one of a variety of different configurations and may be adapted for different engine applications. Although not shown, head 15 may also include various passages that allow one or more fluids such as engine oil and/or engine coolant to flow within, through, and/or around head 15. The flow of engine coolant through head 15 helps to keep the temperature of head 15 relatively cool. According to various alternative and exemplary embodiments, the head may include multiple apertures 23 to receive one or more fuel injectors for each bore 19 of block 13, or for only some of bores 19. According to other exemplary and alternative embodiments, more than one head may be included on an engine 10.

Piston 17 is a generally cylindrical member that is configured to reciprocate within bore 19. Piston 17 fits closely within bore 19 to enable piston 17 to substantially seal combustion chamber 21 to prevent (or substantially prevent) the escape of combustion gases past piston 17 during engine operation. To assist with the creation of an adequate seal, and to help ensure that piston 17 is appropriately lubricated, piston 17 may include one or more piston rings. According to various exemplary and alternative embodiments, the piston may take one of a variety of different configurations.

The crankshaft is an elongated shaft that is coupled to each of pistons 17 and that serves to link and synchronize the movement of each of pistons 17. It also serves as the mechanism by which the linear movement of pistons 17 is converted into rotational movement and the mechanism by which the power generated from the combustion process is captured and made available to other applications (e.g., the transmission, alternator, air compressors, etc.).

Referring still to FIGS. 1 and 2, fuel system 12 is a system of components that cooperate to deliver fuel (e.g., diesel, gasoline, heavy fuel, etc.) from a location where fuel is stored to combustion chambers 21 of engine 10 where the fuel will combust and where the energy released by the combustion process will be captured by the crankshaft of engine 10 and used to generate a mechanical source of power. According to one exemplary embodiment, fuel system 12 includes a tank 14, a transfer pump 16, a high-pressure pump 18, a common rail 20, an electronic control module (ECM) 24, fuel injectors 22, and sleeves 33.

Tank 14 is a storage container that stores the fuel that fuel system 12 will deliver. Transfer pump 16 pumps fuel from tank 14 and delivers it at a generally low pressure to high-pressure pump 18. High-pressure pump 18, in turn, pressurizes the fuel to a high pressure and delivers the fuel to common rail 20. Common rail 20, which is intended to be maintained at the high pressure generated by high-pressure pump 18, serves as the source of high-pressure fuel for each of fuel injectors 22. Each fuel injector 22 is continuously fed fuel from common rail 20 such that any fuel injected by a fuel injector 22 is quickly replaced by additional fuel supplied by common rail 20. ECM 24 is a control module that receives multiple input signals from sensors associated with various systems of engine 10 (including fuel system 12) and indicative of the operating conditions of those various systems (e.g., common rail fuel pressure, fuel temperature, throttle position, engine speed, etc.). ECM 24 uses those inputs to control, among other engine components, the operation of high-pressure pump 18 and each of fuel injectors 22. The purpose of fuel system 12 is to ensure that the fuel is constantly being fed to engine 10 in the appropriate amounts, at the right times, and in the right manner to support the operation of engine 10.

Referring now to FIG. 2, each fuel injector 22 generally serves as a metering device that controls when fuel is injected into the combustion chamber, how much fuel is injected, and the manner in which the fuel is injected (e.g., the angle of the injected fuel, the spray pattern, etc.). Fuel injector 22 is coupled to head 15 and is received within aperture 23 in such a way that fuel injector 22 is able to inject high-pressure fuel into combustion chamber 21 of engine 10. According to one exemplary embodiment, each fuel injector 22 includes a body 26, a needle valve member 28, a control valve 30, and an actuator 32.

Body 26 generally forms the basic structure of fuel injector 22, including the structures that receive other components, flow passages that allow for the flow of fuel from one portion of fuel injector 22 to another, and the structures that maintain fuel injector 22 in an assembled condition. Body 26 may be an assembly constructed from multiple different parts, pieces, or elements that cooperate together to form the general structure of fuel injector 22. According to one exemplary embodiment, body 26 includes a pressure chamber 34, a needle valve seat 36, orifices 38, a control chamber 40, a supply passage 42, a drain passage 44, a control passage 46, and an engagement structure 47.

According to one exemplary embodiment, pressure chamber 34 is a chamber or cavity formed within body 26 that is fluidly coupled to common rail 20 via supply passage 42 and that receives needle valve member 28 in a manner that allows needle valve member 28 to reciprocate between an open position and a closed position. Pressure chamber 34 essentially serves as a reservoir for high pressure fuel that is ready to be injected. Needle valve seat 36 is located within pressure chamber 34 and serves as a surface against which needle valve member 28 seats or seals when it is in the closed position to stop fluid from escaping from pressure chamber 34. Orifices 38 are holes in body 26, located near needle valve seat 36, that allow fluid to escape from pressure chamber 34 when needle valve member 28 is in the open position and that dictate the manner in which fuel is sprayed from fuel injector 22.

According to one exemplary embodiment, control chamber 40 is a chamber or cavity that is configured to cooperate with needle valve member 28 such that the pressure of the fluid within control chamber 40 applies a force to needle valve member 28 (either directly or indirectly through an intermediate member) that urges needle valve member 28 into the closed position. The selective application of force to needle valve member 28 through pressurized fuel within control chamber 40 can be used to control the movement of the needle valve member 28 between the open and closed positions. According to one exemplary embodiment, a portion of needle valve member 28 forms at least one of the walls that defines control chamber 40, such that a pressurized fluid within control chamber 40 urges that portion of needle valve member 28 outward. Control chamber 40 is fluidly coupled to supply passage 42 and to control passage 46. An appropriately sized flow restriction may be provided in one or both of supply passage 42 and control passage 46 to control the rate of flow of fluid into and/or out of control chamber 40.

Supply passage 42, drain passage 44, and control passage 46 are each flow passages, bores, or drillings that are located within fuel injector 22 and that serve to direct fluid to certain parts of fuel injector 22. According to one exemplary embodiment, supply passage 42 serves to direct fluid from common rail 20 to pressure chamber 34, to control chamber 40 (through a flow restriction), and to control valve 30; drain passage 44 serves to direct fluid from control valve 30 to tank 14 (e.g., a low pressure drain); and control passage 46 serves to direct fluid between control valve 30 and control chamber 40.

According to one exemplary embodiment, engagement structure 47 is a reduced diameter portion of body 26 (e.g., an annular groove or channel) that is configured to be engaged by a clamp 49. Clamp 49 is coupled to head 15 and engages engagement structure 47 to retain fuel injector 22 within aperture 23 of head 15. According to various exemplary and alternative embodiments, the engagement structure may take any suitable configuration that cooperates with clamp 49 to retain fuel injector 22 within head 15. Similarly, the clamp may take any one of a variety of different configurations that are suitable to enable the clamp to be coupled to head 15 and to enable the clamp to retain fuel injector 22 within head 15.

Needle valve member 28 is a rigid member that moves between an open position and a closed position to selectively permit the pressurized fluid from within pressure chamber 34 to be injected into combustion chamber 21 through orifices 38. According to one exemplary embodiment, needle valve member 28 has a first end that includes a seating surface 48 and a pressure surface 50, and a second opposite end that includes a pressure surface 52. Seating surface 48 cooperates with needle valve seat 36 of body 26 such that when needle valve member 28 is in the closed position, any flow of fluid out of orifices 38 is substantially prevented. Pressure surface 50 is a surface of needle valve member 28 upon which the pressurized fluid within pressure chamber 34 acts when needle valve member 28 is in the closed position to apply a needle opening force that urges needle valve member 28 into the open position. Similarly, pressure surface 52 is a surface on the opposite end of needle valve member 28 upon which the fluid within control chamber 40 acts to apply a needle closing force that urges needle valve member 28 into the closed position. Because the force acting on pressure surface 50 opposes the force acting on pressure surface 52, the areas of pressure surfaces 50 and 52 are configured so that needle valve member 28 will be retained in the closed position when the fluid pressure within control chamber 40 is approximately the same as the fluid pressure within pressure chamber 34. A biasing member, shown as a spring 54, is coupled between needle valve member 28 and a portion of pressure chamber 34 and applies a biasing force to needle valve member 28 that urges it into the closed position. The biasing force provided by spring 54, which increases the total needle closing force, is taken into account in the configuration of the areas of pressure surfaces 50 and 52. According to various alternative and exemplary embodiments, the areas of pressure surfaces 50 and 52 may vary relative to one another, and the biasing force of spring 54 may be varied, but the areas and the biasing force of spring 54 should be such that needle valve member 28 can be maintained in the closed position when the fluid pressure within control chamber 40 is approximately the same as the fluid pressure within pressure chamber 34. Similarly, the biasing force provided by spring 54 should be small enough that the needle opening force applied to needle valve member 28 by the pressurized fluid within pressure chamber 34 can overcome the biasing force of spring 54.

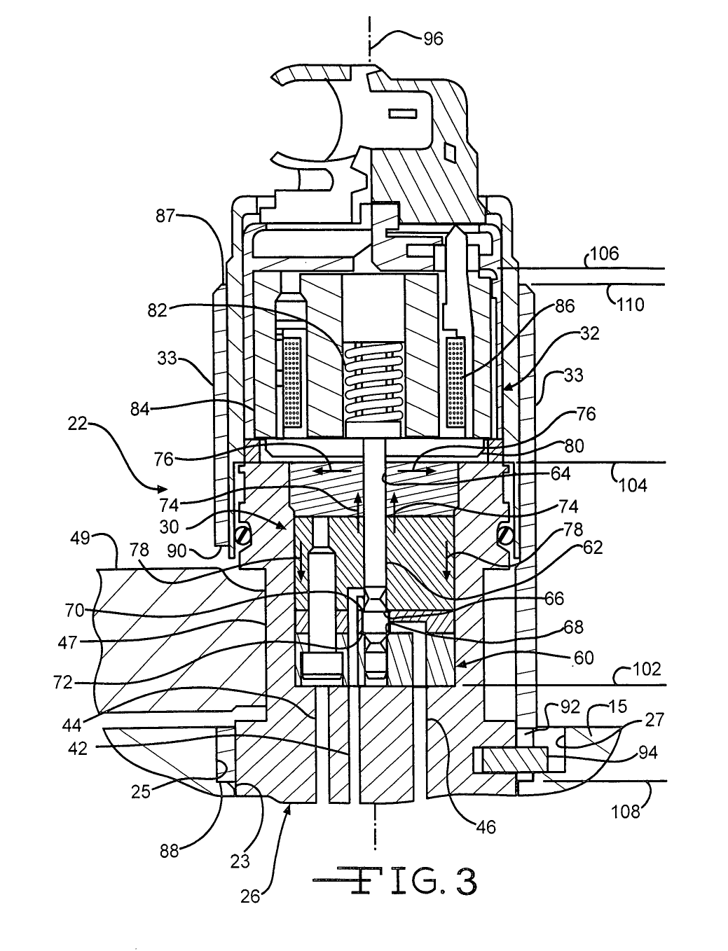

Referring now to FIGS. 2 and 3, control valve 30 is a valve assembly that serves to selectively couple control passage 46 to supply passage 42 or drain passage 44. Stated differently, control valve 30 serves to selectively couple control chamber 40 to either common rail 20 or tank 14. According to one exemplary embodiment, control valve 30 includes a body 60 and a valve element 62. Body 60 is a structure that receives valve element 62 and that cooperates with valve element 62 to selectively open and close fluid connections. Body 60 includes an aperture 64 that closely receives valve element 62 and that defines an upper seating surface 66 and a lower seating surface 68. Valve element 62 is a generally cylindrical member that is received within aperture 64 of body 60. Valve element 62 includes an enlarged portion that provides an upper seating surface 70, which is configured to selectively engage upper seating surface 66 of aperture 64, and a lower seating surface 72, which is configured to selectively engage lower seating surface 68 of aperture 64, depending on the locating of valve element 62. According to one exemplary embodiment, valve element 62 is moveable within body 60 between a drain position, in which upper seating surfaces 66 and 70 are engaged to fluidly disconnect supply passage 42 and control passage 46 and lower seating surfaces 68 and 72 are disengaged to fluidly couple control passage 46 with drain passage 44, and a pressurization position, in which upper seating surfaces 66 and 70 are disengaged to fluidly couple supply passage 42 and control passage 46 and seating surfaces 68 and 72 are engaged to fluidly disconnect control passage 46 and drain passage 44. Valve element 62 is coupled to actuator 32, which controls the movement of valve element 62 between the drain position and the pressurization position.

In the drain position, control valve 30 fluidly couples control passage 46, and therefore control chamber 40, to drain passage 44, which ultimately leads to tank 14. In the pressurization position, control valve 30 fluidly couples control passage 46, and therefore control chamber 40, to supply passage 42, which is coupled to common rail 20. Thus, when control valve 30 is in the drain position, control chamber 40 is fluidly coupled to tank 14, which in turn causes the pressure of the fluid within control chamber 40 to drop below the pressure of the fluid within pressure chamber 34. The drop in fluid pressure in control chamber 40 then allows the fluid in pressure chamber 34 to force needle valve member 28 into the open position. When control valve 30 is in the pressurization position, control chamber 40 is fluidly coupled to supply passage 42, which then causes the pressure of the fluid within control chamber 40 to increase, for example to approximately the same pressure as the pressure of the fluid within pressure chamber 34. The approximate equalization of the fluid pressures in control chamber 40 and in pressure chamber 34, in combination with the biasing force provided by spring 54 and the relative areas of pressure surfaces 50 and 52, then creates a net downward force that acts on needle valve member 28 to move it into the closed position. According to various alternative and exemplary embodiments, the control valve may take any one of a variety of different configurations. For example, the control valve may be a two-way valve, a spool valve, or any other type of valve. The control valve could also be made up of one valve element, or more than one valve element (e.g., it essentially could be two or more valve elements working together to accomplish the fluid connections described above).

Referring now to FIG. 3, although aperture 64 of body 60 is configured to closely receive valve element 62, there will likely be at least some small space between the two. As a result, high pressure fuel from supply passage 42, which enters aperture 64 above cooperating upper seating surfaces 66 and 70, may leak into the small space between the inner diameter of aperture 64 and the outer diameter of valve element 62. Any fuel that does leak into the small space between aperture 64 and valve element 62 will then work its way toward actuator 32 (flow direction 74), then radially outward toward a gap (not shown) between body 60 of control valve 30 and body 26 (flow direction 76), and then downward within that gap (flow direction 78) where it will eventually drain out through drain passage 44.

Referring still to FIG. 3, actuator 32 is an electronically controlled device that is coupled to valve element 62 of control valve 30 and that serves to selectively move valve element 62 between the drain position and the pressurization position in response to an electric signal provided by ECM 24. According to one exemplary embodiment, actuator 32 includes an armature 80, a biasing member 82, and a solenoid 84. Armature 80 is a disk-like element that is coupled to valve element 62. Biasing member 82, shown as a compression spring, is located within an aperture in solenoid 84 and serves to bias valve element 62 (through armature 80) into the pressurization position. Solenoid 84 is a device that includes a coil of wires 86 located within a core or stator that together create a magnetic field when an electrical current is passed through coil 86. Solenoid 84 is configured so that armature 80 is drawn toward solenoid 84 when the magnetic field is created. Spring 82 helps to ensure that armature 80 returns to a position away from solenoid 84 when the flow of current through coil 86 is terminated. Spring 82 is configured to provide a biasing force that is sufficient to force armature 80 away from solenoid 84 when solenoid 84 is deactivated but which may be overcome when solenoid 84 is activated. Because armature 80 is coupled to valve element 62, the movement of armature 80 is transferred to valve element 62. Thus, when solenoid 84 is activated, armature 80 moves toward solenoid 84 causing valve element 62 to move to the drain position. When solenoid 84 is deactivated, armature 80 is pushed away from solenoid 84 by spring 82 causing valve element 62 to move to the pressurization position. According to an alternative embodiment, the solenoid, armature, and spring may be arranged so that activation of the solenoid moves the valve element to the pressurization position while deactivation of the solenoid allows the spring to move the valve element to the drain position. According to other alternative and exemplary embodiments, the actuator may be replaced by any suitable actuation device that controls the movement of the valve element within the body of the control valve. For example, another actuation device or configuration that may be used may include a piezo controlled actuation system, a hydraulically controlled actuation system, or any other suitable actuation system.

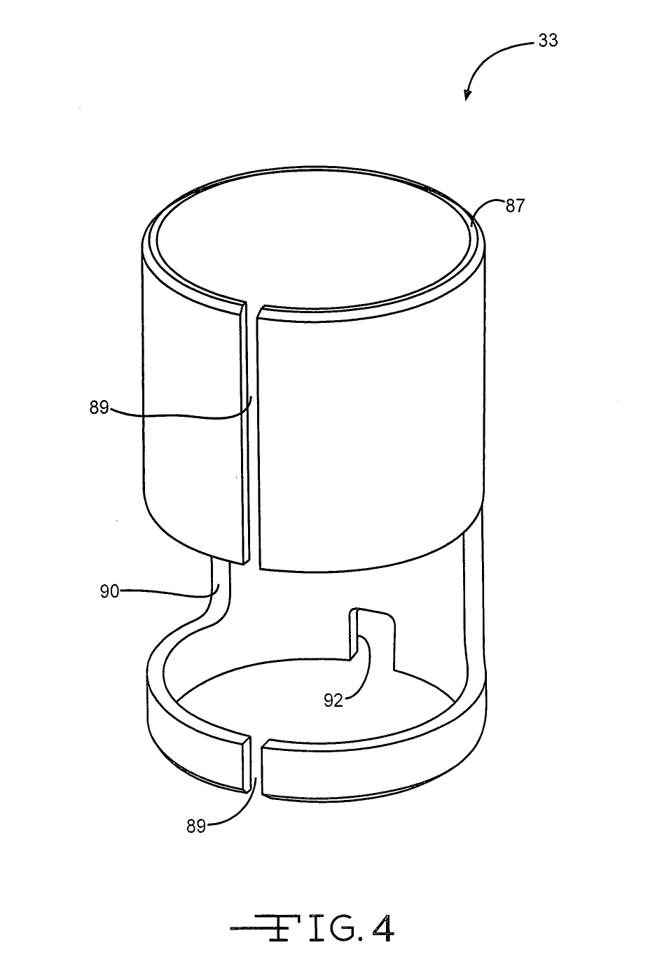

Referring now to FIGS. 3 and 4, sleeve 33 is a component that is coupled to a fuel injector 22 and to head 15 and that is configured to conduct or otherwise transfer heat from fuel injector 22 to head 15. According to one exemplary embodiment, sleeve 33 is a generally tubular member that includes an end 87, an opposite end 88, a split 89, an opening 90, and a notch 92. The distance between ends 87 and 88 defines the length of sleeve 33. Split 89 is a small gap or disconnect in the material forming sleeve 33 that extends the entire length of sleeve 33. The presence of split 89 helps to make sleeve 33 easier to expand to facilitate the coupling of sleeve 33 to fuel injector 22. Opening 90 is an opening in sleeve 33 that has a length that is approximately a third of the length of sleeve 33 and that extends more than 180 degrees around the circumference of sleeve 33. Opening 90 is intended to provide an opening through which clamp 49 is able to engage engagement structure 47 of fuel injector 22. Notch 92 is a relatively small opening that extends a relatively short distance into end 88 of sleeve 33. Notch 92 may be configured to accommodate and receive an indexing or alignment pin 94 that may be provided on fuel injector 22 to ensure that fuel injector 22 is properly oriented within aperture 23 of head 15. According to various alternative and exemplary embodiments, the sleeve (including the split, opening, and notch) may take a variety of different shapes, sizes, and configurations. According to other alternative and exemplary embodiments, the sleeve may not include either or both of the opening and the notch. According to still other alternative and exemplary embodiments, the shape and size of the opening may depend on the configuration of clamping arrangement used to retain fuel injector 22 within head 15.

According to various exemplary embodiments, sleeve 33 is made from a suitable heat conducting material. According to one exemplary embodiment, sleeve 33 is made from copper. According to another exemplary embodiment, sleeve 33 is made from aluminum. According to various alternative embodiments, sleeve 33 may be made from any material that is capable of conducting heat between fuel injection 22 and head 15 (e.g., gold, silver, etc.), and an appropriate material may be selected based on the degree of thermal conductivity that is desired for a particular application. According to various alternative and exemplary embodiments, the sleeve may be made from one or more of a variety of different manufacturing techniques. For example, depending at least in part on the material or materials from which the insert is constructed, the insert may be molded, cast, machined, forged, extruded or otherwise manipulated to achieve its final shape and form.

According to one exemplary embodiment, sleeve 33 is at least partially resilient and is coupled to fuel injector by expanding sleeve 33 (which is facilitated by split 89), placing sleeve 33 around the appropriate location of fuel injector 22, and then allowing the resiliency of sleeve 33 to return sleeve 33 to its original shape. Depending on the resiliency of sleeve 33, once sleeve 33 has been expanded and placed in the appropriate location relative to fuel injection 22, sleeve 33 could also be physically closed back around fuel injector 22 so it fits tightly around fuel injector 22. Regardless of the method used to couple sleeve 33 to fuel injector 22, the area of contact between sleeve 33 and fuel injector 22 should be as great as possible to provide for the greatest heat conductance. Once sleeve 33 has been coupled to fuel injector 22, fuel injector 22 is inserted into aperture 23 of head 15 and the portion of sleeve 33 near end 88 is press-fit into recess 25 of head 15. According to various alternative and exemplary embodiments, the sleeve may be coupled to the fuel injector and to the head using any one of a variety of different techniques and/or processes (e.g., through threaded interfaces, welding, brazing, adhesives, various clamps or clips, etc.).

Referring now to FIG. 3, the placement of sleeve 33 relative to control valve 30 and/or actuator 32 may have an effect on the amount of heat that is conducted away from fuel injector 22 by sleeve 33. The relative locations of control valve 30, actuator 32, and sleeve 33 within fuel injector 22 may be defined in relative terms according to a position along an axis 96 that extends through the center of fuel injector 22 in a longitudinal direction. Thus, control valve 30 may be defined as extending generally between an axial position 102 and an axial position 104, actuator 32 may be defined as extending generally between axial position 104 and an axial position 106, and sleeve 33 may be defined as extending generally between an axial position 108 and an axial position 110. According to one exemplary embodiment, axial position 108 (the lower end of sleeve 33) is located below axial position 102 (the lower end of control valve 30) and axial position 110 (the upper end of sleeve 33) is located near axial position 106 (the upper end of actuator 32). In such a configuration, sleeve 33 will be coupled to fuel injector 22 in a position that enables sleeve 33 to substantially surround both actuator 32 and control valve 30. According to another exemplary embodiment, the area between axial positions 110 and 108 (the upper and lower ends of sleeve 33, respectively) overlaps the area between axial positions 106 and 104 (the upper and lower ends of actuator 32, respectively). According to another exemplary embodiment, the area between axial positions 110 and 108 (the upper and lower ends of sleeve 33, respectively) overlaps the area between axial positions 104 and 102 (the upper and lower ends of control valve 30, respectively). According to other exemplary and alternative embodiments, the area between axial positions 110 and 108 (the upper and lower ends of sleeve 33, respectively) may overlap any portion of the area between axial positions 106 and 104 (the upper and lower ends of actuator 32, respectively) and/or any portion of the area between axial positions 104 and 102 (the upper and lower ends of control valve 30, respectively). According to still other alternative and exemplary embodiments, the sleeve may be located in any position on fuel injector 22 that allows the sleeve to be close to a source of heat within fuel injector 22.

### INDUSTRIAL APPLICABILITY

As discussed above, fuel injectors 22 are used to inject high pressure fuel into the combustion chambers 21 of engine 10 and generally serve as metering devices that control when fuel is injected into the combustion chambers 21, how much fuel is injected, and the manner in which the fuel is injected. According to one exemplary embodiment, fuel injector 22 operates in the following manner. Fuel injector 22 receives pressurized fuel from common rail 20. Within fuel injector 22, supply passage 42 directs the pressurized fuel to pressure chamber 34, control chamber 40, and control valve 30. Within pressure chamber 34, the pressurized fuel acts upon pressure surface 50 of needle valve member 28 and applies a needle opening force to needle valve member 28 that urges needle valve member 28 into the open position. Within control chamber 40, the pressurized fuel acts upon pressure surface 52 of needle valve member 28 and applies a needle closing force to needle valve member 28 that urges needle valve member 28 into the closed position. In addition to the forces acting on needle valve member 28 from the pressurized fuel with pressure chamber 34 and control chamber 40, spring 54 is coupled to needle control valve member 28 in such a way that it applies an additional needle closing force to needle valve member 28.

Spring 54, pressure surface 50, and pressure surface 52 are configured to cooperate with one another such that when the pressure of the fuel within pressure chamber 34 is approximately equal to the pressure of the fuel within control chamber 40, the total resultant force acting on needle valve member 28 is a needle closing force that moves needle valve member 28 into, or maintains needle valve member 28 in, the closed position. When needle valve member 28 is in the closed position, needle valve member 28 prevents (or substantially prevents) any flow of fuel out of orifices 38. However, when the pressure of the fuel within control chamber 40 is reduced by a sufficient amount, the total needle closing force provided by the fuel within control chamber 40 and spring 54 will be reduced to the point where the needle opening force provided by the pressurized fuel within pressure chamber 34 (which will normally be at approximately the pressure of common rail 20) is greater than the total needle closing force. When this occurs, needle valve member 28 moves into the open position and pressurized fuel from pressure chamber 34 is allowed to flow out of orifices 38 and is injected into combustion chamber 21 (either directly or indirectly) of engine 10.

Control valve 30 generally serves to control the injection of fuel out of fuel injector 22 (e.g., the flow of fuel out of orifices 38) by controlling the pressure of the fuel within control chamber 40. To control the pressure within control chamber 40, control valve 30 moves between the pressurization position and the drain position to selectively couple control passage 46 and control chamber 40 to supply passage 42 (which is fluidly coupled to the pressurized fuel from common rail 20) or drain passage 44 (which is fluidly coupled with tank 14), respectively. To start injection, control valve 30 moves from the pressurization position to the drain position. This has the effect of coupling control chamber 40 to tank 14, which allows the needle opening force acting on needle valve member 28 to overcome the needle closing forces, which moves needle valve member 28 into the open position. To end injection, control valve 30 moves from the drain position to the pressurization position. This has the effect of coupling control chamber 40 to common rail 20 (via both supply passage 42, which is always fluidly coupled to control chamber 40, and control passage 46), which allows the needle closing forces acting on needle valve member 28 to overcome the needle opening force, which moves needle valve member 28 into the closed position. Actuator 32, which is controlled by ECM 24, controls the movement of control valve 30 between the pressurization position and the drain position.

To move control valve 30 from the pressurization position to the drain position against the bias of spring 82, an electrical current (energy) is sent through coils 86 of solenoid 84 to create a magnetic field that attracts armature 64 and draws it toward solenoid 84. Because armature 64 is coupled to valve element 62 of control valve 30, the movement of armature 64 also results in the movement of valve element 62. Each time electrical current, or energy, is sent to solenoid 84, at least some of that energy is dissipated in the form of heat energy. When multiple injection strategies are desired, control valve 30 needs to be actuated more often. In order to actuate control valve 30 more often, more energy is usually needed. As more energy is provided to solenoid 84, more energy is dissipated as heat. Thus, the more frequently solenoid 84 is activated or energized, the more heat solenoid 84 will generate.

In addition to the heat generated by solenoid 84, the high pressure fuel that leaks past valve element 62 of control valve 30 provides a source of heat. When the fuel leaks into the small gap between the inner diameter of aperture 64 and the outer diameter of valve element 62, the pressure of the fuel drops significantly. When the pressure of the fuel drops, at least some of the energy of the high pressure fuel is converted into heat energy. As a result, the temperature of the fuel increases substantially. In some cases, depending on magnitude of the change in pressure, the temperature of the fuel could increase as much as 100 degrees Celsius or more. As the fuel travels around and through control valve 30 in flow directions 74, 76, and 78 (see FIG. 3), at least some of the heat from the fuel is transferred to the surrounding areas.

As a result of the heat energy dissipated from solenoid 84 and the high pressure fuel that leaks within control valve 30, the area of fuel injector 22 around solenoid 84 and control valve 30 may be exposed to a substantial amount of heat energy. In some cases, if left unaddressed, the heat energy could be enough to damage actuator 32. By coupling sleeve 33 to fuel injector 22 in a position where sleeve 33 substantially surrounds at least one of solenoid 84 (or actuator 32) and control valve 30, and by also coupling sleeve 33 to head 15, at least some of this heat energy may be conducted or otherwise transferred to sleeve 33 and then to head 15, which will often be maintained at a lower temperature due to the engine coolant that is passed through it. Thus, by coupling sleeve 33 between head 15 and the portion of fuel injector 22 where a substantial amount of heat is generated, sleeve 33 may serve as a conduit for the transfer of heat energy from fuel injector 22 to head 15.

According to one exemplary embodiment, sleeve 33 may be used alone to transfer excess heat energy away from fuel injector 22. According to other exemplary embodiments, sleeve 33 may be used along with other heat reduction techniques. For example, engine oil could be sprayed onto fuel injector 22 or otherwise placed in contact with fuel injector 22 to achieve some transfer of the heat to the engine oil. As another example, the fuel injector 22 could be exposed in some fashion to the engine coolant that flows through head 15 to achieve some transfer of the heat to the engine coolant.

It is important to note that the construction and arrangement of the elements of the fuel injector and sleeve as shown in the exemplary and alternative embodiments is illustrative only. Although only a few embodiments of the recited subject matter have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, orientations, etc.) without materially departing from the novel teachings and advantages of the subject matter recited. For example, elements shown as integrally formed may be constructed of multiple parts or elements shown as multiple parts may be integrally formed, the operation of the interfaces (e.g., seating surfaces, valve positions, the interfaces between the sleeve and the fuel injector and the head, etc.) may be reversed or otherwise varied, and/or the length, width, or thickness of the structures and/or members or connectors or other elements of the system may be varied. It should be noted that the elements and/or assemblies of the fuel injector and/or the sleeve may be constructed from any of a wide variety of materials that provide sufficient conductivity, strength and/or durability; in any of a wide variety of textures and combinations; and through any one or more of a variety of suitable manufacturing process. It should also be noted that the sleeve may be used in association with different areas of a fuel injector; in association with a variety of different types of fuel injectors (including, without limitation, mechanically or hydraulically actuated unit injectors or different common rail fuel injectors) and a variety of different types of fuel systems; or in association with any one of a wide variety of other components such as different hydraulic or electric components, including without limitation fuel pumps, hydraulic valve systems used to control a portion of an engine's valvetrain, etc. Accordingly, all such modifications are intended to be included within the scope of the present disclosure. Other substitutions, modifications, changes and omissions may be made in the design, operating conditions and arrangement of the exemplary and alternative embodiments without departing from the spirit of the recited subject matter.

What is claimed is:

1. An engine comprising:
a block including at least one bore;
a piston configured to reciprocate within the bore;
a head coupled to the block, the head defining with the block and the piston a combustion chamber;
a fuel injector coupled to the head and configured to deliver fuel to the combustion chamber, the fuel injector including an actuator extending between a first axial position and a second axial position along a longitudinal axis of the fuel injector; and
a sleeve coupled between the head and the fuel injector, the sleeve extending between a third axial position and a fourth axial position along the axis of the fuel injector;
wherein the area between the first and second axial positions at least partially overlaps the area between the third and fourth axial positions.

2. The engine of claim 1, wherein the sleeve is made from a heat conducting material.

3. The engine of claim 2, wherein the sleeve is copper.

4. The engine of claim 2, wherein the sleeve is aluminum.

5. The engine of claim 1, wherein the sleeve includes a longitudinal split.

6. The engine of claim 5, wherein the sleeve is coupled to the fuel injector through a spring fit.

7. The engine of claim 5, wherein sleeve is received within an annulus in the head.

8. The engine of claim 7, wherein the sleeve is coupled to the head through a press fit.

9. The engine of claim 1, wherein at least a portion of the sleeve is located outside of the head.

10. The engine of claim 1, further comprising a clamp coupling the fuel injector to the head, and wherein the sleeve includes an opening configured to receive at least a portion of the clamp.

11. The engine of claim 1, wherein the actuator is a solenoid.

12. The engine of claim 1, further comprising a control valve extending between a fifth axial position and a sixth axial position, and wherein the area between the fifth and sixth axial positions at least partially overlaps the area between the third and the fourth axial positions.

13. An engine comprising:
a block including at least one bore;
a piston configured to reciprocate within the bore;
a head coupled to the block, the head defining with the block and the piston a combustion chamber;
a fuel injector coupled to the head and configured to deliver fuel to the combustion chamber;
a clamp coupling the fuel injector to the head; and
a sleeve coupled between the head and the fuel injector, the sleeve including an opening for receiving at least a portion of the clamp;
wherein the sleeve is configured to conduct heat between the fuel injector and the head.

14. The engine of claim 13, wherein the sleeve is copper.

15. The engine of claim 13, wherein the sleeve is aluminum.

16. The engine of claim 13, wherein the sleeve includes a longitudinal split.

17. The engine of claim 13, wherein the fuel injector includes an actuator and wherein the sleeve at least partially surrounds at least a portion of the actuator.

18. The engine of claim 13, wherein the fuel injector includes a control valve assembly and wherein the sleeve at least partially surrounds at least a portion of the control valve assembly.

19. A method of coupling a fuel injector to a head of an engine comprising the steps of:
expanding a split sleeve;
sliding the sleeve onto the fuel injector in an expanded state;
coupling the sleeve to the head.

20. The method of claim 19, wherein the fuel injector includes an actuator and wherein the step of sliding the sleeve onto the fuel injector further comprises the step sliding the sleeve onto the fuel injector until at least a portion of the sleeve is located at approximately the same axial position along an axis of the fuel injector as at least a portion of the actuator.

21. The method of claim 19, further comprising the step of coupling a clamp to the head and to the fuel injector.

22. The method of claim 21, wherein the sleeve includes an opening and wherein the step of coupling the clamp further comprises the step of coupling the clamp to the fuel injector through the opening in the sleeve.

23. The method of claim 19, wherein the step of coupling the sleeve to the head further comprises the step press-fitting the sleeve within a bore in the head.
